(19) United States
(12) Patent Application Publication
(10) Pub. No.: US 2010/0049097 A1
(43) Pub. Date: Feb. 25, 2010

(54) Anatomical flexion apparatus, system, and method

(76) Inventors: John M. O'Brien, Portland, OR (US); Patrick D. Boyd, Portland, OR (US)

Correspondence Address: ATER WYNNE LLP, 1331 NW Lovejoy St. Suite 900, PORTLAND, OR, 97209-2785, US

(21) Appl. No.: 12/229,440

(22) Filed: Aug. 22, 2008

(51) Int. Cl. A61H 1/00; A61G 7/002

(52) U.S. Cl. 601/1; 5/600

(57) ABSTRACT

An anatomical flexion apparatus comprising a relatively rigid base structure, and a pivot member coupled with and typically traversing a distance between opposing support members of the base. An arrangement of articulable platform members is generally operatively coupled with the pivot member, wherein one or more of the platform members are independently pivotable about a longitudinal axis of the pivot member. Typically, one or more radial translation members are operatively coupled with one or more drive mechanisms, and are further configured to urge one or more of the platform members through an arc of motion having a range found within a range of approximately zero to approximately one hundred eighty (0-180) degrees.

### FIELD OF THE INVENTION

The invention relates generally to the field of physiologic therapy and development devices and methods. More particularly, the invention relates to an apparatus, system, and method for safely and effectively flexing anatomical portions of a human subject for health maintenance, injury recovery, and/or musculoskeletal development.

### BACKGROUND OF THE INVENTION

There is strong general recognition that lower trunk (e.g., abdomen, lower back, and hips) strength and flexibility play an important part in proper musculoskeletal function and health. This fact is also demonstrated by the proliferation of a great variety of exercise devices, classes, and instructional media for developing ‘core’ (torso) strength and flexibility.

For example, currently marketed abdominal and lower back exercise devices operate by applying a load through the use of weights, deformable elastic members, or combinations thereof, against which a user applies an opposing force while flexing and/or extending the targeted muscle groups of the lower trunk. Such devices are typically designed specifically and exclusively for either abdominal or lumbar muscle development, not both, and do not typically include features for enhancing flexibility and range of motion. Additionally, all motion must typically be supplied by the muscle power of the user. Such devices typically require that one portion of the body, for example the upper trunk or the legs, remain immobile to provide leverage while the user moves an opposing body portion through a prescribed path of motion.

Alternatively, such devices as exercise balls, popular for a large number of core strength development programs, allow greater variety in movement of a body part during use. However, due to the inherent instability of such devices, they generally require that a user maintain at least one and typically both feet in contact with the floor or another stable structure, to prevent the ball from rolling and dumping the user onto the floor. Additionally, many people, especially the elderly for whom falls present heightened dangers, and the overweight for whom exercise balls may not be sufficiently robust, do not feel secure and confident enough to use exercise balls for many exercises.

Generally speaking, most devices on the market target development of strength and muscular definition of the lower trunk, and are not intended, designed, or effective to develop and promote flexibility and/or an increased range of motion in the lower trunk. There further remain a great number of individuals who do not have the physical ability, for a variety of reasons, to utilize such devices and/or methods. This group includes the elderly, those with injuries or otherwise compromised lower trunk strength and/or mobility, overweight individuals, and others.

Devices such as adjustable hospital beds allow elevating a portion of a subject's anatomy relative to another portion, such as the knees or upper body, but only to a relatively limited extent. For example, a bed may enable raising an individual's knees while the upper body remains relatively horizontal, or vise versa. Typically, however, upper body elevation cannot exceed forty-five (45) degrees relative to horizontal, with leg elevation being even more limited. Additionally, beds which enable substantial declination of the upper body portion are unknown to the inventors.

Further still, adjustable beds are entirely unknown wherein a user can articulate the adjustable portions of a bed through a pre-programmed range of motions. Adjustable beds are simply neither intended, designed, nor functional for such purposes.

### BRIEF DESCRIPTION OF THE DRAWINGS

FIG. 1a depicts in side elevation view an apparatus with extendable platform members, according to an embodiment of the invention.

FIGS. 1b-1c depict in side elevation view an apparatus in a neutral position according to alternative embodiments of the invention.

FIGS. 2a-2c depict in end elevation view the apparatuses of FIGS. 1a-1c, respectively, according to alternative embodiments of the invention.

FIGS. 3a-3c depict in plan view the apparatuses of FIGS. 1a-1c, respectively, according to alternative embodiments of the invention.

FIG. 4 depicts the apparatus of FIG. 1a in side elevation view in an operating position, according to an embodiment of the invention.

FIGS. 5a-5c depict in plan view, side elevation view, and end sectional view, respectively, details of a pivotable platform coupling arrangement, according to an embodiment of the invention.

### DETAILED DESCRIPTION OF THE PREFERRED EMBODIMENTS

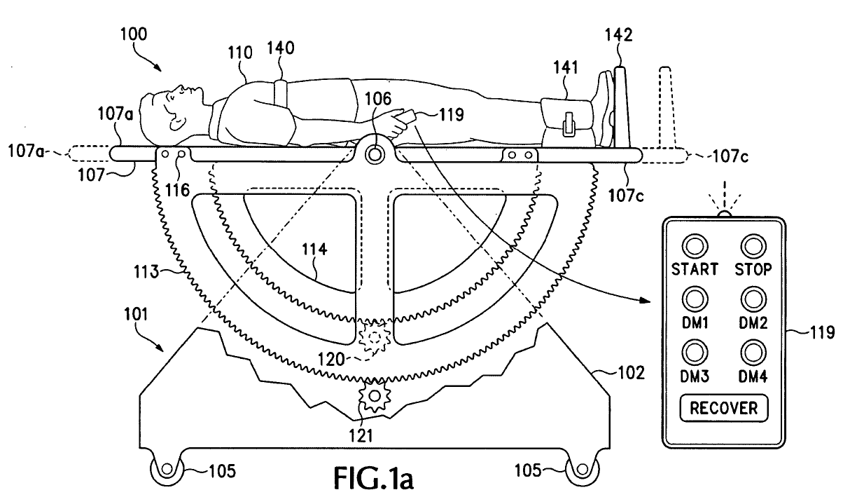

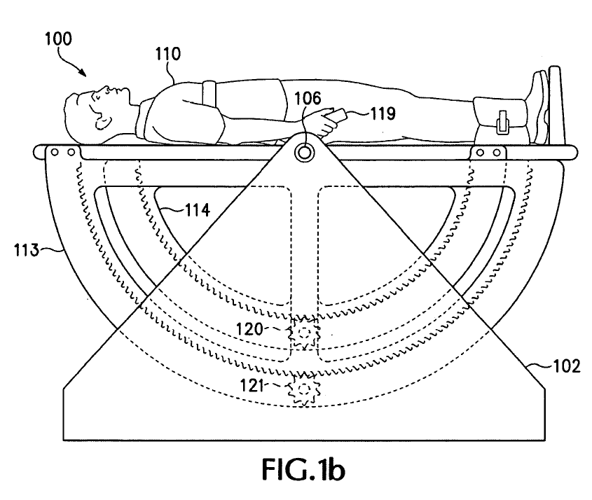

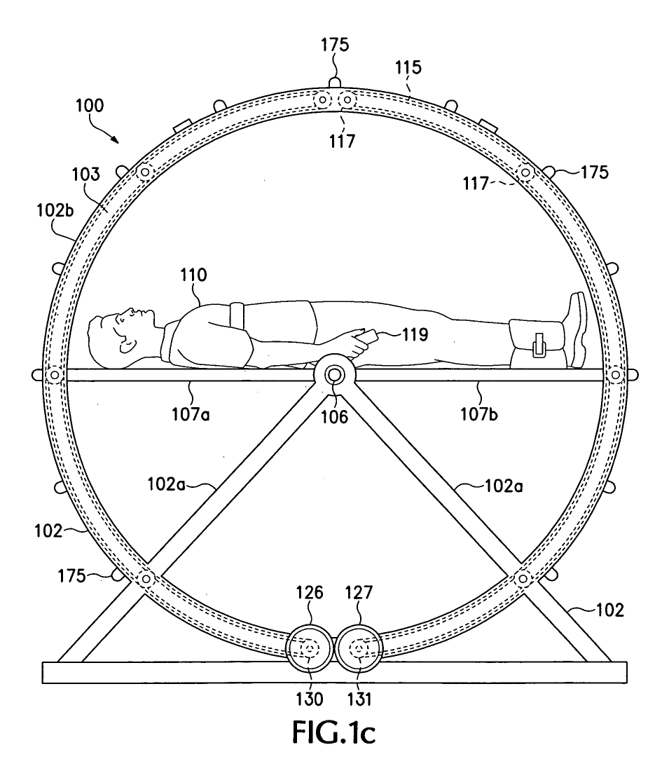

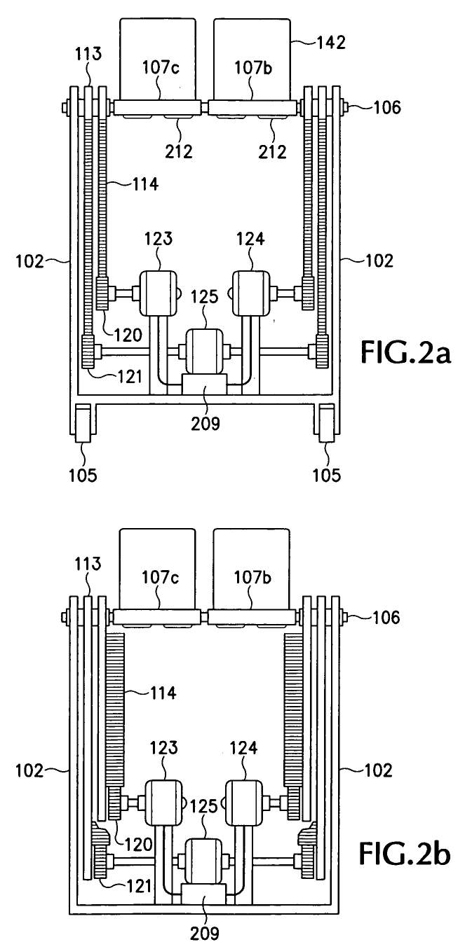

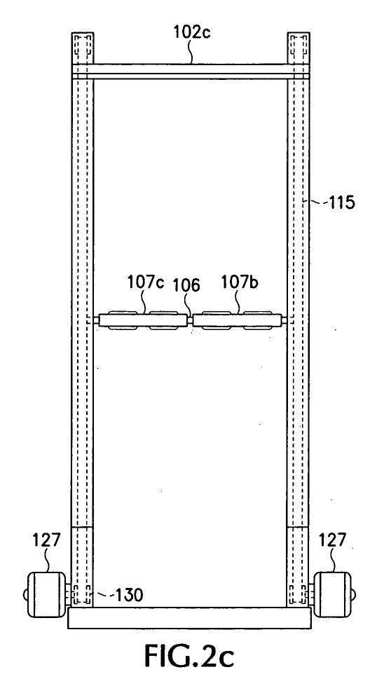

Referring to the figures, FIGS. 1a-1c depict in side elevation view alternative embodiments of the invented apparatus. With regard to FIG. 1a, a preferred but non-exclusive embodiment, an apparatus 100 generally comprises a relatively rigid supporting structure (e.g., a base) 101 with which most of the moving components of the apparatus 100 are operatively coupled either directly or indirectly. The base 101 can comprise an integrally formed or fastened (e.g., welded, bolted, etc.) single structure, but may alternatively comprise two or more opposing support members 102 or arrangements of support members, as also shown in FIG. 2a.

The opposing support members 102 can be relatively planar, as shown in FIG. 1a, such as when formed from or including a sheet of material (e.g., metal, rigid polymer, wood, etc.) or a combination of materials. So configured, a support member 102 may act as a barrier between users and potentially dangerous moving components located in whole or in part within a periphery of the apparatus. Alternatively, support members 102 can comprise beams, bars, tubes, columns, or other relatively rigid structural forms, and can be arranged and/or coupled into a configuration providing substantial rigidity and support to the other components and to apparatus 100 overall.

Support members 102 can also have any of a multitude of cross-sectional configurations, including round, square, rectangular, triangular, perpendicular (e.g., shaped like a letter “T”, “I”, “H”, “L”, etc.), or others, or a combination thereof. Generally, support members so formed provide substantial structural rigidity under even relatively large loads. However, “relative rigidity” referred to throughout this specification typically indicates a capability to withstand loads and forces reasonably expected through normal use and transportation of an apparatus, to ensure safety of a user, to prevent damage and/or premature wear to the apparatus and/or its components, and otherwise to ensure continued proper and safe operation of the apparatus.

In alternative embodiments, an arrangement of support members 102a can be relatively triangular, as shown in side elevation view in FIG. 1c, or may be relatively square, rectangular, or nearly any other shape or combination thereof. As also shown in FIG. 1c, a support structure 102 can comprise opposing relatively circular support structure portions 102b, each of which can include a recessed raceway portion 103 extending substantially around an entire periphery thereof, such as to accommodate a force conveying mechanism 115 therein. In such an embodiment, with reference also to FIG. 2c, one or more additional structural support members 102c can traverse between and couple with each of opposing relatively circular support members 102b, providing additional stability thereto, and maintaining a consistent distance therebetween during use, despite the application of motive, gravitational, and/or other forces thereto.

The base 101 can be further configured in an embodiment to provide one or more means for transporting the apparatus 100 from a first relatively stationary location to a second relatively stationary location. For example, it may be advantageous or even necessary to periodically reposition an apparatus 100 within a room, or from one room to another. Therefore, in an embodiment with reference to FIG. 1a, a transporting means can include one or more rolling components (e.g., wheels, casters, roller bars, etc.) 105, low friction pads or skids (e.g., surfaced with a fluoropolymer, smoothly polished metal, etc.), or some other structure or combination thereof for transporting an apparatus across a substrate surface. In general, any other device, structure, or arrangement of components suitable for moving an relatively heavy apparatus with relative ease and safety to users, the apparatus 100, and/or substrate surfaces (e.g., floors) can comprise a transporting means contemplated within the scope of the invention.

Transporting means 105 can be integrally coupled with apparatus 100, can be retractable and deployable, or can be entirely removable and replaceable. Thus, in addition to rolling, sliding, or other transport-enabling components, transporting means 105 can include any and all other structural accommodations provided to receive, attach, detach, deploy, or otherwise operatively couple such components with base 101 to aid transporting apparatus 100. For example, this could include fasteners, openings, brackets, axles, retracting devices, steering devices, handles or other such components, and is not limited to those expressly listed here, but rather includes any equivalents now known or later developed that provide benefits for transporting apparatus 100 (e.g., changing a location of, or altering a position of, base 101 relative to a substrate).

In at least one embodiment, transporting means 105 can be a vehicle within which apparatus 100 is placed and secured, or with which apparatus 100 can be integrally and relatively permanently coupled. In such embodiments, the vehicle itself can be considered a transporting means, and apparatus 100 can be transported from one facility to another (e.g., to a user's home, business, or other location) for increasing mobility of and access to an apparatus. That is, the apparatus can be taken to the users, rather than the users coming to the apparatus.

A fulcrum member 106 (also known as a “pivot member”) is typically operatively coupled with and extends between two or more opposing support members 102/202 of the base in an embodiment (e.g., traversing at least a portion of a distance therebetween). A fulcrum member 106 is also typically arranged relatively horizontally (e.g., level, and/or parallel with an underlying substrate, etc.), and includes a longitudinal axis 206 extending therethrough (as shown in FIG. 2a). In alternative embodiments, an apparatus may include two or more fulcrum members 106, at least one of which is coupled with each of two or more opposing support members 102 of base 101, and longitudinal axis 206 is defined by and between two oppositely positioned fulcrum members 106. For at least the reasons that longitudinal axis 206 is generally defined by fulcrum members 106, fulcrum members may also be referred to herein as axial members, and shall be understood to be equivalent thereto unless otherwise indicated.

As also shown in the embodiment of FIG. 2a, a transverse fulcrum member 106 in the embodiment of FIG. 1a is located proximate to, operatively coupled at, and traverses a distance between the apices 202 of two or more opposing support members 102. However, alternative embodiments may vary. For example, as shown in FIGS. 1c and 2c, a transverse fulcrum member 106 may also operatively couple with and traverse between opposing support members 102a at a position approximately centered within the circular portions 102b of each of the opposing support members 102.

Likewise, in the case of alternatively formed (e.g., non-triangular) base support members (e.g., square, rectangular, etc.), support members may not form a recognized “apex”, but a transverse fulcrum member 106 will nonetheless be positioned at and traverse between elevated portions of opposing support members of the base.

In at least one embodiment, the fulcrum member 106 is fixedly coupled with one or more of the support members 102, and is not rotatable about longitudinal axis 206, in whole or in part. Alternatively, fulcrum member 106 can be securely coupled with one or more support members 102 while also being rotatable about longitudinal axis 206 in whole or in part. For example, fulcrum member 106 can comprise a plurality of components which are moveable relatively to each other. One such arrangement of components can include a shaft portion passed through a tubular portion, wherein opposing ends of the shaft portion are coupled with the support members 102, while the tubular portion lies entirely between the opposing support members 102, and is rotatable about the shaft portion. Rotation may be facilitated by a lubricant disposed between the shaft portion and the tube portion, or by an arrangement of bearings or other structures therebetween and adapted to facilitate rotational movement of one component relative to another.

Alternatively, each support member 102 can include an attached or integrally-formed receiving structure configured to receive and pivotably retain a portion of a fulcrum member 106. For example, an opening, sleeve, bracket, or other structure can be provided at a portion of the support member(s), the opening or other structure having at a fulcrum member-receiving surface a low friction material (e.g., including fluoropolymer pads, etc.) or one or more rotating components (e.g., configured as or including bearings, etc.). Thus, a portion of fulcrum member 106 operatively coupled with support member 102 is rotatable along axis 206 relative to the one or more support member(s) 102.

Although the described embodiments illustrate several alternative configurations of a fulcrum member 106, the embodiments are not so limited. A cross-sectional shape of the fulcrum member 106, perpendicular to the longitudinal axis 206, can be round, rectangular, square, triangular, ovoid, or nearly any other shape, regular or irregular, according to alternative embodiments. Alternatively, rather than a single fulcrum member 106, an apparatus 100 can comprise two or more fulcrum members, each of which is operatively coupled with at least one support member 102 of the apparatus 100.

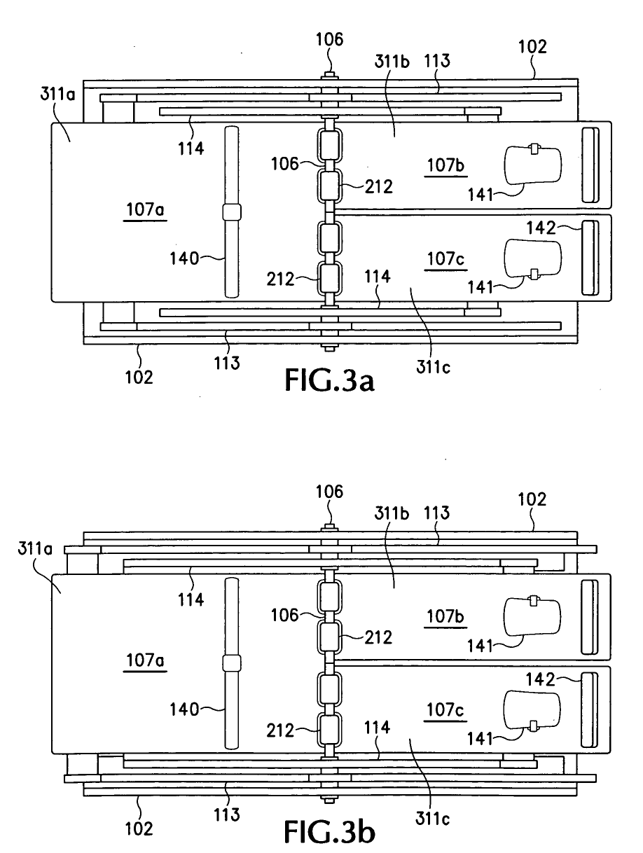

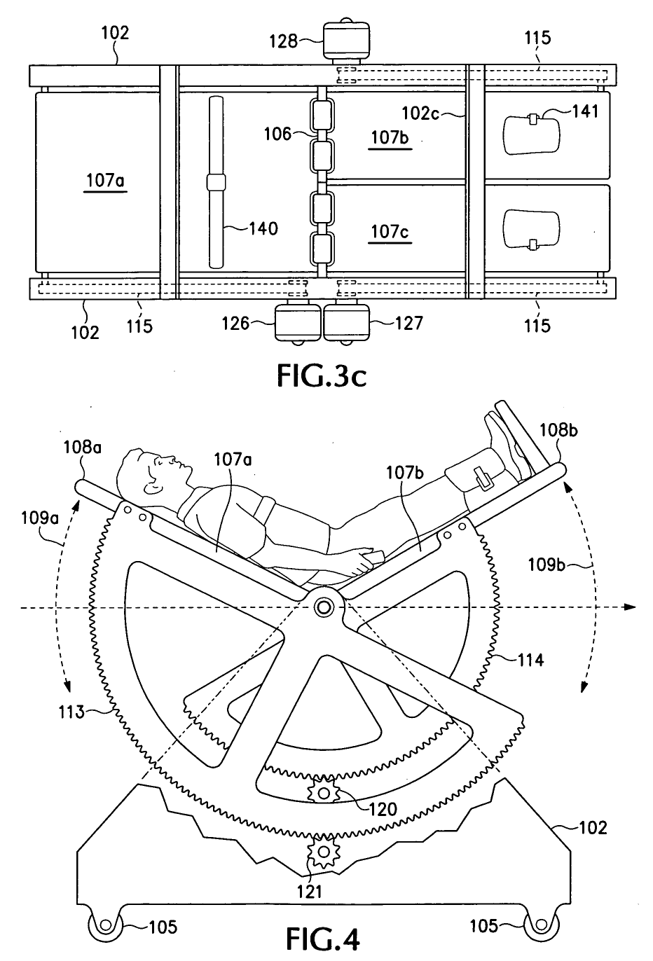

As further depicted in FIGS. 1a-1c, and in plan view of FIG. 3a, apparatus 100 includes in embodiments an articulable platform arrangement 107 that comprises two or more independently movable (e.g., pivotable, articulable, etc.) support platform members. For example, in the typical but non-exclusive embodiment with reference to FIG. 3a, the platform arrangement comprises a torso support portion 107a and one or more lower extremity (e.g., leg) support portions 107b/107c.

Inasmuch as a subject may lie either prone or supine (as shown in FIG. 1a) upon the platform arrangement, and due to the fact that an apparatus may be relatively bilaterally-symmetrical in many respects and according to alternative embodiments, any reference to a “right” or “left” portion of the platform arrangement 107 or the apparatus as a whole stated herein, is assigned relative to a supinely disposed user as depicted in FIGS. 1a-1c. However, such left and/or right designations are intended to be illustrative, rather than limiting, and are provided for clarity and simplicity of description within this specification.

As shown in FIG. 3a, one or more of the platform members 107a-107c is typically operatively coupled with or otherwise relative to the fulcrum member 106. Such operative coupling generally enables one or more of the platform members 107a-107c to pivot relative to a longitudinal axis 206 of the fulcrum member 106, and through and/or along an arc of motion having the longitudinal axis 206 at its center. For example, FIG. 4 depicts each of platform members 107a-107c pivoted upwardly relative to their respective positions in FIG. 1a, with the path of the distal ends 108a/108b of each of the torso support portion 107a and the leg support portion(s) 107b/107c, respectively, describing an arc of motion 109a/109b throughout the pivoting thereof relative to an axis 206 of a fulcrum member 106.

For clarity of description herein, a distance between an axis 206 about which a platform member 107a-107c is pivotable, and any point along an arc of motion 109a/109b relative to a corresponding axis (e.g., 206), is referred to herein as a radius of the arc (e.g., “arc radius”) so described. Similarly, an arc of motion, as described herein and contemplated according to embodiment of the invention, typically comprises a portion of a circle having an axis 206 at its center, and further comprising a subset of a maximum of 360 degrees. For example, an arc of motion of ninety (90) degrees includes a portion of a platform member 107a-107c traversing throughout one-quarter (¼) of a full circle about a central axis 206. An arc range of motion for any particular component of an apparatus 100 herein, or of any portion thereof, typically describes a full range of motion that can be traversed by that component or portion thereof during normal operation, according to an embodiment.

With respect to the embodiments depicted in FIGS. 1a-1c, for simplicity of description herein and without any intent to limit the embodiments, a circle having its center laying at the longitudinal axis 206 (when viewed in side elevation view) is conceptually bisected into two halves (each half having one hundred eighty (180) degrees), by a linear plane extending along the longitudinal axis 206 as well as upward and downward. Each of the opposing semicircular arcs thusly bisected possesses a common zero (0) degree position lying at a position where the bisecting plane intersects the circle below the platform arrangement 107, and a common one hundred eighty (180) degree position lying at a position where the bisecting plane intersects the circle above the platform arrangement 107. Therefore, as shown, each of the platform members 107a-107c in FIG. 1a are shown in a “neutral” ninety-degree position.

In alternative embodiments, each of the platform members 107a-107c can have either equivalent or disparate arc ranges of motion. Typically, however, and as depicted in the embodiments of FIGS. 1a-1c, each of the pivotable platform members 107a-107c is independently pivotable throughout all or nearly (substantially) all of an arc range of motion (“arc of motion”) between an approximately zero degree position and an approximately one hundred eighty degree position (e.g., a 0-180 degree arc of motion).

As also depicted in FIGS. 1a-1c and 3a, at least one of the platform members (e.g., 107a) extends outwardly from the fulcrum member in a first direction, while one or more of the other platform members (e.g., 107b/107c) extends outwardly from the fulcrum member in a second direction. Thus, platform member 107a is pivotable about a longitudinal axis 206 of fulcrum member 106 through a first arc of motion having a range found within the range of zero to one hundred eighty (0-180) degrees, and each of platform member(s) 107b/107c are likewise pivotable through a similar but opposing second arc of motion having a range of approximately zero to one hundred eighty degrees, but wherein the opposing ranges of motion are typically substantially or completely non-overlapping.

Each platform member 107a-107c can also be said to have a longitudinal axis which lies perpendicularly (or approximately perpendicularly) relative to the longitudinal axis 206 of the fulcrum member 106. Each platform member also typically, although not exclusively, includes a relatively planar upper surface 311a-311c configured to receive a human subject 110 (e.g., user) disposed thereupon, as depicted in FIGS. 1a-1c. A “relatively” planar surface in embodiments can include non-planar portions, whether depressed or elevated relative to a nominal surface plane, and whether originally configured or formed during use, such as to received and comfortably support a portion of a user (e.g., knees, heels, neck, etc.).

One or more of the platform members 107a-107c can each be integrally formed of a single expanse of a relatively rigid and/or supportive material (e.g., a sheet of wood, metal, polymer, etc.) or combination of materials, or can be formed of a structural framework sufficiently supportive to receive and maintain a user in an operative position throughout a range of motion. Disposed at an upper, user-receiving surface 311a-311c of a platform member 107a-107c may also be a pliable, cushioning material or composition in embodiments, further supporting and providing comfort to a user operably disposed thereupon.

As depicted in FIGS. 1a-1c, each of the one or more platform members 107a-107c are typically pivotably coupled with fulcrum member 106. Alternatively, each of platform member 107a, 107b, or 107c can include features provided at a proximal end (at or adjacent to a pivot axis 206) which operatively and/or pivotably couple with reciprocal features of an opposing other of platform members 107a, 107b or 107c, collectively forming a fulcrum member 106 or a portion thereof, and defining a longitudinal axis 206. In such embodiments, at least a portion of platform members 107a-107c will likewise operatively couple with one or more of the support members 102.

Disposed along fulcrum member 106 and intermediate platform members 107a-107c, embodiments may also include one or more roller members 212 (FIGS. 2a and 3a). Roller members 212 can be configured to rotate about a longitudinal axis 206 in response to and/or enabling positional adjustments of a user 110 relative to the fulcrum member 106 and/or one or more of the platform members 107a-107c during use.

Referring again to FIGS. 1a-1c, an apparatus typically includes one or more radial translation members 113/114/115 configured to translate one or more of the platform members 107a-107c through an arc of motion having a range within the range of approximately zero to approximately one hundred eighty (0-180) degrees. Generally, at least one radial translation member is operatively coupled with at least one independently pivotable platform member. For example, as seen in FIG. 1a, radial translation member 113 is coupled with platform member 107a by one or more fasteners 116 extending through a portion of radial translation member 113 and securely engaging platform member 107a. Numerous alternative coupling arrangements are likewise contemplated, and include any equivalents now known or later developed.

A radial translation member 113/114/115 is generally configured to receive an applied force, and to translate that force to the one or more platform members 107a-107c, causing the platform member(s) to pivot through all or some portion of an arc range of motion. Each radial translation member may need to lift or otherwise articulate not only one or more platform members, but also all or some portion of a user disposed thereupon, who can be either slight or ample in proportions. Therefore, a radial translation member is typically formed of a sufficiently robust (e.g., rigid) material and configuration, to lift or otherwise articulate at least several hundred pounds, and in an embodiment, at least a thousand pounds or more. Numerous embodiments are contemplated which meet these requirements, as well as others which will be described below.

As shown according to the embodiments of FIG. 1a-1b and 2a-2b, radial translation members 113 and 114 can be configured as relatively planar semicircular gear members rotatably coupled at a relatively central portion with a fulcrum member 106. Each radial translation member 113/114 so configured can comprise a relatively continuous expanse, or can have sections removed (e.g., cutouts, similar to the drive gears on a bicycle, etc.) to reduce the overall weight and/or material used, while maintaining a high resistance to deformation in response to an applied load (e.g., linear and/or rotational force).

To achieve these ends, radial translation members 113/114 can be formed from an expanse of sufficiently thick metal or another relatively strong and rigid material. For example, a thickness found within the range of one-eighth inch to one half inch (⅛″-½″) is considered sufficiently thick in one or more embodiments. In other embodiments, a generally thinner expanse of material can be used when reinforced with operatively-coupled strengthening members, a framework, and/or with integrally-formed thickened portions configured to provide resistance to deformation in response to an applied load.

As seen in the embodiment of FIGS. 1a-1b and 4, one or more of the radial translation members 113/114 may typically be pivotably (e.g., rotatably) coupled at a relatively radial center position with one of a fulcrum member 106 or with a support member 102 of the base 101. Rotation of the one or more radial translation members 113/114 is therefore typically about an axis formed by and/or relative to that relatively radial center coupling arrangement of the translation member(s) 113/114. Typically, two or more opposing radial translation members will share a common rotational axis. This arrangement, however, does not describe all conceived embodiments.

As also seen in FIG. 4, each of radial translation members 113 and 114 is independently pivotable relative to one another, and is capable of urging an operatively coupled platform member 107a-107c through an arc of motion independently from at least another platform member. Thus, each of the user-receiving surfaces 311a-311c of a plurality of platform members 107a-107c can be positioned at approximately ninety (90) degrees within their respective arc ranges of motion, forming a relatively planar platform arrangement 107 to receive a prone or supine user positioned thereupon.

Subsequently, a position of one or more platform members 107a-107c can be altered within its respective arc range of motion, therefore altering an angle formed between a subject-receiving surface of one platform member relative to a subject-receiving surface of at least another platform member. As can be understood from this description and the accompanying figures, such altered angle can be either acute or obtuse.

Additionally, in embodiments having separate platform members for each leg of a user, one leg supporting platform member can form an obtuse angle with a torso supporting platform member in a first cooperative position, while another leg supporting platform member forms an acute angle with the torso supporting platform member in a second cooperative position. Such independent movement provides numerous alternatives for flexing a lower trunk of a human subject, to achieve a plurality of physiological benefits and/or objectives.

Alternatively, opposing platform members (e.g., torso-supporting and leg-supporting), can be moved in opposite directions (e.g., inclined vs. declined), but while maintaining an approximately planar overall platform arrangement (e.g., an approximately one hundred eighty degree angle between the user-receiving surfaces of the respective platform members). Thus, throughout the full arc ranges of motions available in an embodiment, an initially supine human subject can be inclined to an approximately vertical standing position (e.g., such as for entering or exiting the apparatus), and can likewise be declined into an approximately fully-inverted position, wherein the subject's feet are directly above the subject's head, or nearly so. Each position, as well as each intermediate position within a full arc range of motion of the respective platform members, can provide benefits to a user, and therefore are generally achievable in an embodiment of the invention.

Referring to the FIGS. 1a-1b, translation members can be configured as relatively planar semicircular gears 113 and 114 positioned adjacently and relatively parallel-planar with respect to one another proximate to an end of (or proximate both ends of) a fulcrum member 106. When so configured, at least a portion of a first gear 113 bypasses and substantially overlaps at least a portion of the second gear 114 as each of the first gear 113 and/or the second gear 114 independently proceed through at least a portion of their respective opposing pivotable arcs of motion about a longitudinal axis of the fulcrum member 106. This positional relationship is clearly visible with reference to FIGS. 3a and 4.

As depicted, translation member 113 is located outwardly from translation member 114, and a diameter of translation member 114 is sufficiently reduced relative to that of translation member 113. Therefore, that translation member 114 obtains free rotation without conflicting with, and within a radius of a position at which translation member 113 is coupled with platform member 107a.

As shown in the embodiment of FIG. 1c, a radial translation member 115 can also be formed as one or more curvilinear force conveying mechanisms (“conveyor mechanism”) 115 arranged substantially with and at least partially translatable throughout a raceway portion 103 formed as a portion of a relatively circular support member 102b. For example, a conveyor mechanism 115 can be configured as a chain comprising a plurality of pivotably-coupled links, a reinforced flexible belt, a plastic-coated metal cable, or another relatively equivalent curvilinear member or arrangement as currently known or later developed.

As discussed relative to the radial translation members 113/114 of FIGS. 1a-1b, the one or more radially-translating conveyor mechanisms 115 of FIG. 1c will generally need to lift and/or otherwise articulate several hundred pounds in an embodiment. However, the forces that conveyor mechanisms 115 will generally be configured to withstand are more typically tensile forces. Therefore, the conveyor mechanisms 115 will typically be configured sufficiently robust to withstand expected tensile forces either individually, or as combined in a plural arrangement wherein two or more conveyor mechanisms 115 support a single platform member 107a-107c.

A radially-translating conveyor mechanism 115 can engage one or more translation guide mechanisms 117 disposed at one or more locations relative to a raceway portion 103. Translation guide mechanisms 117 may take numerous forms utilizing any of numerous materials, may be either fixed or movable, and can be coupled with other components to provide one or more beneficial functions. In a common embodiment, a translation guide mechanism 117 is configured as a rotating wheel-like arrangement either partially or entirely exposed within raceway portion 103 and configured to engage a conveyor mechanism 115. Examples include a toothed gear configured to engage links of a bicycle chain-type conveyor mechanism, a pulley configured to engage a cable or belt-type conveyor mechanism, or other similar and/or equivalently-functioning mechanisms or arrangements.

Alternatively, a translation guide mechanism 117 can be a unitary and/or composite structure of a low-friction material (e.g., fluoropolymer, etc.), or a material having a relatively smooth and wear-resistant surface, positioned at least partially within a raceway portion 103 and configured to engage a radially-translating conveyor mechanism. Such embodiments of a translation guide mechanism 117 can be fixed in place, wherein the conveyor mechanism slides across a surface thereof during translation, and can be a replaceable component when and/or if subject to performance and/or dimensional degradation due to wear.

A low-friction material can be positioned at several locations in a raceway 103 throughout a translation path of a conveyor mechanism 115, and/or can be disposed along the entire path or a substantial portion thereof, providing a relatively constant low-friction engagement with the conveyor mechanism 115. Of course, in alternative embodiments, an apparatus 100 can utilize one or more different embodiments of translation guide mechanisms 117 without departing from the spirit of the invention, and such embodiments are not limited to those specifically described herein, but include any equivalents thereof now known or later developed.

Not only will one or more translation guide mechanisms 117 disposed at one or more portions of a raceway portion 103 generally help to guide and retain a conveyor mechanism 115 as the conveyor mechanism articulates throughout and within a raceway portion, but numerous additional benefits may likewise be obtained according to the embodiments. Translation guide mechanisms 117 can additionally reduce friction between a conveyor mechanism 115 and other components of an apparatus 100 during translation, thus decreasing wear of the conveyor mechanism 115 and other components, decreasing generated noise during operation, and preventing and/or reducing heat generated by friction.

Additionally, at least one translation guide mechanism 117 in an embodiment can be provided with a tensioning means configured to maintain and/or adjust an operative tension of the conveyor mechanism 115 during radial translation thereof. A tensioning means can include, be configured as, or be operatively coupled with any of a spring-force exerting mechanism (e.g., coil spring, rotary spring, cantilevered spring, etc.), a compressible or extensible gas-powered device (e.g., pneumatic cylinder, etc.), or any equivalent thereof now known or later developed capable of asserting a tension-adjusting influence on a conveyor mechanism operatively engaged therewith.

One having skill in the art will also recognize from the descriptions provided herein that in at least one embodiment, an arrangement of translation guide mechanisms 117 disposed to retain and guide a curvilinear conveyor mechanism 115 throughout a translation path can obviate a need for a structurally-defined raceway portion 103 entirely. Therefore a structurally-defined raceway portion 103 is not included in all embodiments of an apparatus 100 similar to that depicted in FIG. 1c, however, a path traversed by each of the one or more conveyor mechanisms 115 can still be conceptually considered a raceway.

As substantially depicted in FIG. 1c, a conveyor mechanism 115 can typically comprise a contiguous loop, or circuitous band, engaging and circulating around a translation guide mechanism or other device positioned at or near each of an upper terminus and/or a lower terminus of an arc of motion. Thus, while an inwardly positioned portion of the radial translation conveyor mechanism 115 (e.g., relative to the circular support member(s) 102b) travels upward during operation (e.g., when elevating a platform member 107a through an arc of motion), another outwardly positioned portion of the same radial translation conveyor mechanism 115 travels downwardly and bypasses a substantial portion of the upwardly traveling portion. Conversely, reversing a direction of travel of the conveyor mechanism 115 presents the converse situation.

Generally, a platform member 107a-107c is operatively and consistently coupled with a portion of a corresponding conveyor mechanism configured for that purpose, such that the platform mechanism 107a-107c moves through an arc of motion in correspondence with that portion of the conveyor mechanism. However, in alternative embodiments, such coupling position can be varied relative to the conveyor mechanism, by providing a coupling means configured to engage, for example, any link in a chain-type conveyor mechanism 115, or by clamping onto or otherwise engaging any portion of a cable or belt-type conveyor mechanism.

In an alternative embodiment, a terminal end of a non-circuitous conveyor mechanism extends upward from a lower extent of an arc of motion (e.g., relative to a circular support member 102b), over an upper translation guide mechanisms 117 and operatively couples with a platform member. A lower portion of the conveyor mechanism 115 engages a drive mechanism configured to “reel in” and/or “spool out” at least a portion of the conveyor mechanism during operation.

In such embodiments, a take-up mechanism located at or near a lower extent of an arc of motion takes up excess portions of the conveyor mechanism when a platform member is elevated above the lower extent, and feeds out those portions of the conveyor mechanism as the platform member is lowered below an upper extent of an arc of motion. Therefore, slack conveyor mechanism portions are avoided throughout a range of motion, while providing sufficient conveyor mechanism length to urge a platform member 107a-107c throughout up to an approximately one hundred eighty (180) degree range of motion.

A take-up mechanism can be configured as a spool or some other structure onto which a portion of the conveyor mechanism is gathered and/or from which it is distributed, and can be spring loaded to maintain tension on the conveyor mechanism. A take-up mechanism can also include a braking mechanism configured to control a speed at which a portion of conveyor mechanism is released from the take-up mechanism, such as by engaging and/or releasing in response to a change in a rate of take-up and/or release, or exceeding or subsiding below a threshold rate thereof, by the take-up mechanism.

As can also be understood from FIG. 1c, an apparatus 100 can include two or more conveyor mechanisms 115, at least one on each of opposing halves of a relatively circular arrangement of one or more support members 102b. Each of two or more opposing platform members 107a-107c can be coupled with one of the opposing conveyor mechanisms, such that each of the platform members 107a-107c can be independently inclined and/or declined through an arc of motion by translating each of the conveyor mechanisms independently from each other conveyor mechanism.

A plurality of platform members 107a-107c can share a common pivot axis for each of their independent and opposing arcs of motion, but the embodiments are not so limited. Alternatively, each of a plurality of platform members can have an independent pivot axis from at least an opposing platform member, such as when two or more fulcrum members 106 are present in an embodiment. In such embodiments, however, each of a plurality of fulcrum members and/or pivotal axes will generally be relatively adjacently positioned, and will generally be orientated in parallel with respect to one another.

Referring to FIGS. 2a-2c, operatively coupled with at least one of the radial translation member 113/114, and typically with each translation member, is a drive mechanism 124/125. Each drive mechanism may be operatively coupled with only one translation member, as shown at each of 123 and 124 in FIG. 2a for example, or an embodiment may include a drive mechanism operatively coupled with more than one translation member, as shown at 125 in FIG. 2a.

A drive mechanism 123/124/125, as operatively configured in an embodiment, generates a force, and by an operative engagement with one or more radial translation members 113/114, applies all or some portion of the generated force to the radial translation member(s). The one or more radial translation members 113/114 then, by an operative coupling with the one or more platform members 107a-107c as earlier described, translates (e.g., conveys, applies, delivers) a force to the platform member(s) 107a-107c corresponding to the force generated by the drive mechanism(s) 123-125.

In a preferred but non-exclusive embodiment, one or more of the drive mechanisms 123-125 are electrical motors configured with a shaft member 122 extending therefrom, wherein applying an electrical charge to the drive mechanism causes the shaft member to rotate about a longitudinal axis thereof at a rate, and with a force, each of which corresponds in one or more respects to a characteristic of the electrical signal. Thus, altering a characteristic of the applied electrical charge alters one or more of a rotational rate and/or a torque (rotational) force generated in the shaft 122 by the drive mechanism 123-125

As seen in FIGS. 1a, 2a, and 4, a shaft member 122 extending from a drive mechanism 123-125 can include an engagement member 120/121 configured to operatively engage a radial translation member 113/114, and by such engagement, enable a rotational motion and force generated by a drive mechanism 123-125 to impart a corresponding rotational motion and force to the translation member 113/114. In a typical but non-exclusive embodiment, an engagement member 120/121 is configured as a gear including a plurality of “teeth” relatively evenly disposed about a circular or relatively circular periphery of the engagement member 120/121. The teeth of the engagement member 120/121 engage a correspondingly arranged plurality of teeth disposed about a semicircular periphery of a translation member 113/114.

Rotating the shaft member 122 causes the teeth of the engagement member 120/121 to apply a motive force against one or more of the teeth of a translation member 113/114, urging the translation member to rotate about a longitudinal pivot axis 206 in a rotational direction contrary to that of the engagement member 120/121. As a translation member 113/114 rotates, the teeth of the engagement member 120/121 continue to sequentially engage and apply force to the teeth of the translation member until a corresponding platform member 107a-107c reaches a pre-determined angle. The engagement member 120/121 then either ceases to rotate, or alternatively, begins to rotate in an opposite direction as driven by the drive mechanism 123-125.

The teeth of a translation mechanism 113/114 can be arranged along a curved peripheral edge thereof, as depicted in FIGS. 1a, 2a, and 4. Alternatively, as depicted in FIGS. 1b and 2b, the teeth of a translation mechanism can be arranged along another curved portion of a semicircular translation mechanism, located inwardly from the periphery. In the embodiments depicted in FIGS. 1b and 2b, a portion of the outer periphery of each translation mechanism 113/114 extends outwardly relatively to the pivot member 106, overlapping the engagement member(s) 120/121. Each engagement mechanism 120/121, as shown, engages with a curved flange which extends perpendicularly from and relative to a general plane of the translation member(s) 113/114

The scope of the invention, however, includes alternative configurations of toothed arrangements, as well as non-toothed engagement mechanisms. For example, an a portion of an engagement mechanism can form a friction-based engagement with a portion of a translation member, with a force being imparted to the translation member by the moving engagement member due to a level of friction therebetween exceeding the level of the imparted force.

In another embodiment, a curvilinear member (e.g., cable, chain, belt, etc.) is coupled at each end of a linear portion of a semicircular translation member (proximate each end of the curved peripheral portion thereof, the curvilinear member extending downward to and around an engagement member substantially configured as a pulley. Therefore, rotating the engagement member takes in the curvilinear member extending toward and coupling with one side of the translation member, and feeds the taken up curvilinear member out on an opposite side of the engagement member from whence it is taken up. Thus, an end of the translation member is pulled downwardly toward the engagement member, causing the translation member to rotate about a rotational axis 206.

As will be recognized by those having skill in the art, a large number of engagement configurations are possible, and are contemplated within the scope of the invention although not expressly described herein.

For example, FIGS. 1c and 2c depict a pulley-type engagement mechanism coupled with a drive mechanism 126/127/128 at each semicircular half of a relatively circular support member 102a at a right side of the apparatus 100 (relative to the depicted human subject 110). As also shown, each of the engagement mechanisms engages a continuous belt-type radial translation conveyor member 115, and a rotation of the engagement member(s) 130/131 causes each of a respective Same as above 115 to translate along and throughout a raceway 103. Movement of the conveyor mechanism 115 conveys and translates a force applied by the engagement mechanism(s) 130/131 to a platform member 107a/107b operatively coupled therewith, causing the platform member to articulate through at least a portion of an arc range of motion.

As would be understood by one having skill in the art, an arrangement of gears (e.g., gear train) and/or relatively equivalently-functioning components can be configured between a drive mechanism and an engagement member, enabling a shaft rotating at a first speed to cause an engagement member to rotate at a second speed which is either higher or lower than the first speed. Likewise, a similar and/or alternative arrangement of components can cause a first rotational force (torque) at the shaft to be increased or decreased at the engagement mechanism coupled therewith, enabling an apparatus so configured to utilize a low torque drive mechanism while applying a relatively higher torque force to a translation member.

Additionally, an arrangement of components can enable a user to vary a force applied to and/or an articulation speed of a platform member. Such capabilities are possible by operatively coupling a device or arrangement of devices functionally and/or structurally similar to a vehicle transmission with or within an arrangement of a drive mechanism, a shaft, and an engagement member. When so configured, one or both of a variable speed and/or variable applied force can be controlled manually and/or automatically, mechanically and/or electronically, and spontaneously and/or according to a predetermined plan (e.g., program).

Each of FIGS. 2a, 2b, and 3b depicts an apparatus including three drive mechanisms. However, embodiments are also contemplated which include as few as one drive mechanism, or as many drive mechanisms as an apparatus has translation members, or a number of drive mechanisms found somewhere within this range.

Electrical power for actuating a drive mechanism can be derived from an electrical power supply of a relatively permanent structure within which an apparatus is retained (e.g., by plugging into a power outlet or otherwise connecting to a power supply within a building or facility, etc.), or from a battery-based power source, or by some combination thereof. Alternatively, power may be provided in whole or in part, by a fuel-powered generator system (e.g., a gasoline-powered electrical generator). In still another embodiment, a mobile apparatus coupled to and/or within a vehicle can also derive power in whole or in part from either or both of a battery or a power generation system (e.g., alternator) of the vehicle.

Although a preferred embodiment includes one or more electrically powered drive mechanisms, the embodiments are not so limited, and alternative drive mechanisms are also contemplated. For example, an apparatus can be driven by an internal combustion-powered drive mechanism, or any other equivalents as now known in the art or later developed. An embodiment can also include an uninterruptable power supply (UPS) 209 configured to provide operational power to the apparatus in the event that a primary power source is interrupted, generally but not exclusively through an unexpected event. The UPS 209 can be integrally coupled with the apparatus itself, referencing to FIGS. 2a-2b, such as by being installed within or proximate to the structure of base 101, or it can be separately located but operably coupled with the apparatus by an electrically conductive transmission medium (e.g., copper wire, etc.). Therefore, even in the event of an unexpected power interruption, a user can maintain operable control over an apparatus and return the platform members to a neutral position allowing a subject to exit the apparatus without significant risk of injury or undue delay. In at least one embodiment, one or more of the movably-configured portions of an apparatus are manually movable by a human rather than by, or in addition to, an electrically-powered mechanism.

In alternative embodiments, a drive mechanism can be used to urge either or both of a torso supporting platform member and/or one or more leg supporting platform members in a rotational movement (arc of motion) either cooperatively with a human subject's applied muscular force (e.g., by applying an assistive force to help a subject lift a leg, or perform a sit-up, etc.), to urge an entirely passive human subject through a range of motions (e.g., to maintain flexibility and muscular movement in a comatose or injured person, etc.), or antagonistically relative to a human subject's applied muscular force (e.g., by applying a resistive force throughout a range of motion to develop the subject's muscular strength).

Altering a level of force applied at a platform member by a drive mechanism in alternative embodiments enables increasing and/or decreasing an amount of human muscular force required to articulate a body part through a portion of an arc range of motion, helping to develop muscular strength and mobility for users having a wide range of initial muscular development and/or capabilities.

Additionally and/or alternatively, a translation member can be configured to provide either a relatively constant force throughout a range of motion, or to provide a relatively variable force throughout a range of motion. For example, a translation member can be configured and/or operatively coupled with a variable-tension system (e.g., resilient deforming members providing variable tension throughout a range of motion as in some BOWFLEX exercise systems, or a non-circular cam device or arrangement as in some NAUTILUS exercise systems), a variable friction-applying system (e.g., a friction-based braking system), a variable-load system (e.g., cables and weights) or some other system, device, or arrangement of components configured to alter an amount or level of motive force required to articulate the translation member through an arc of motion.

Additionally, an apparatus according to an embodiment can be configured with one or more force-sensing devices and/or systems configured to detect a level of force (e.g., resistance to motion) applied upon one or more of a platform member, a radial translation member, or a drive mechanism by a human subject disposed at a portion of the platform arrangement. Additionally, when a force applied by a human subject and opposing a force applied by a portion of the apparatus exceeds a pre-determined threshold, the apparatus can be configured for one or more of increasing, decreasing, or terminating either of a motive (e.g., assistive) force or a resistive force being applied by a portion of the apparatus. Such configuration and capability provides important benefits in several circumstances.

Firstly, in a muscular development application, where a user seeks to develop muscular strength by applying a muscular force through a range of motion, an opposing antagonistic force applied by the apparatus can automatically increase and/or decrease upon detection that a muscular force applied by the user has exceeded a predetermined threshold. By increasing an opposing force, the apparatus can force the user to increase an applied muscular force to achieve movement of a portion of the apparatus through a range of motion. By decreasing an opposing force, the apparatus ensures a user can move a portion of the apparatus through a full range of motion even though the user's physical condition (e.g., strength, lack of flexibility, etc.) may not permit the user to apply a continuous high level of force throughout a full range of motion.

Secondly, in a therapeutic application, wherein an apparatus is used to articulate portions of a relatively passive user through a range of motion, an apparatus can sense resistance applied by a user due to approaching a maximum extent of the user's flexibility in a given direction of movement. In response, the apparatus can reduce or terminate a motive force applied to the user in that direction of movement, such as to prevent injury, or to hold the user at a current position to achieve gradual lengthening of muscles, tendons, and other anatomical portions.

Thirdly, in any application, a person assisting and/or otherwise attending to a user utilizing the apparatus can apply a supplementary force to a platform member or translation member to assist a user in attaining a target level of applied force, similar to a spotter in weight lifting applying an assistive lifting force. Alternatively, such assisting and/or attending person can intervene by applying a force to a portion of the apparatus to cause the apparatus to terminate an applied motive force, such as in an emergency situation where a user might otherwise be injured by proceeding through a full range of motion in response to a motive force applied by the apparatus.

Numerous force-measuring devices, components, and arrangements of components are known in the art, and do not require extensive discussion herein. One or more force-measuring means can be operatively coupled with one or more of a platform member, a radial translation member, a drive mechanism, or another portion of the apparatus, and can function either mechanically (e.g., as a force-actuated mechanical interlock), electrically (e.g., by producing and conveying an electrical signal to induce a response in an electrically operated control device, system, etc.), or some combination thereof. Further, the term “force-measuring” as used herein includes measurement of any of strain, load, torque, stress, pressure, and/or other properties or characteristics useful to achieve the functions and/or purposes as described above.

As will be understood from the above provided descriptions, an embodiment of the invention further includes one or more drive mechanism control means operatively coupled with the one or more drive mechanisms 123-125, with reference to FIGS. 2a and 2b, or other portions of an apparatus. A drive mechanism control means can be mechanical in construction and/or operation, such as a centripetal clutch configured to limit a rotational speed of a portion of the apparatus, or a torque-limiting device configured to limit an amount of force applied by a rotating portion of the apparatus, although the mechanically-configured embodiments are not so limited. A drive mechanism control mean can also be at least partially configured as electrical components and/or systems.

In one embodiment with reference to FIGS. 1a-1c, a drive mechanism control means, such as a handheld device 119, includes one or more of the following: a programming interface to enable altering one or more operational parameters of an apparatus or some portion thereof; a processor-based drive control circuit to process data received from a user, an apparatus, another portion of drive mechanism control means 119, or from some other source; and one or more drive signal channels to convey a control signal and/or sensor signal between control means 119 and the apparatus or some other device or system. Of course, control means 119 can include and/or be operatively coupled with numerous other devices and/or system, including but not limited to a display device, a data input/output (I/O) device, a networking and/or communication device, a data storage device, etc.

With reference to FIGS. 1a-1c, control means 119 can be configured to receive data input (e.g., input by a user, accessed at a memory means, received via a data transmission, etc.) corresponding to one or more operational parameters, and can convey a corresponding and/or responsive operative signal to one or more drive mechanisms of an apparatus. Operational parameters can include data corresponding to an applied motive and/or resistive force, a rotational or translational speed of one or more portions of an apparatus, a duration of time for one or more operations of the apparatus, an initial and/or final position for one or more portions of the apparatus, and/or others. These controlled modes of a drive mechanism may be respectively represented as Start, Stop, DM 1-4, and Recover.

More specific examples of operational parameters include those relating to translation of a radial translation member and/or conveyor member, including an extent of translation within a total available range of motion, a rate of speed of translation throughout all or some part of an arc of motion, a schedule of repetitive bi-directional translations within an arc of motion, and a level of applied force during translation, although this is not an exclusive list, and others may be included in an embodiment. In general, operational parameters include data corresponding to any position, motion, and/or sequence of positions and/or motions, of any portion of an apparatus, and any characteristic affecting or defining any position, motion, and/or sequence of positions and/or motions, of any portion of an apparatus.

Operational parameters can be pre-determined (e.g., prior to operating an apparatus engaged by a human subject), or can be input or adjusted during operation of an apparatus (e.g., altered in response to a signal received from a sensor of the apparatus, etc.). Operational parameters can be pre-determined by a user (e.g., user-programmable), or determined according to some other guideline, authority, entity, program of operation(s), or schedule of operation (e.g., including plural sequential forces and/or motions). Operational parameters can be received and/or input by the adjustment of a physical control (e.g., a dial, lever, button, keypad, touch-sensitive screen, etc.), or by a signal transmitted wirelessly (e.g., infrared, radio-frequency, etc.) or by a tangible transmission medium (e.g., optical fiber, electrically-conductive wire, etc.).

In embodiments, a human subject disposed at one or more platform members of an apparatus can have access to a control means 119 (e.g., panel, button, transmitter, etc.) configured to enable the subject to initiate, alter, or terminate an operation and/or operational parameter of an apparatus, either of before or during operation of the apparatus.

Additionally, an apparatus can include in embodiments one or more sensor means (e.g., devices) 175 deployed at and/or operatively coupled with one or more portions of an apparatus (e.g., at one or more portions of a support structure, a radial translation member, etc.), and configured to detect a position of one or more portions of an apparatus relative to one or more other portions of an apparatus (e.g., a rotational position of a radial translation member within an arc range of motion, etc.). A sensor means 175 can be any of mechanically, electrically, magnetically, optically, thermally, or otherwise operable. Additionally, a sensor means 175 in an embodiment is configured to convey or transmit to a control means a signal including data indicating a detected position of a portion of the apparatus.

For example, a sensor means 175 can include a trigger member that is actuated by a portion of a radial translation member arriving at a position within an arc range of motion and engaging the trigger member, thus closing (or opening) an electrical circuit and causing a signal to be sent to the control means. Alternatively, a sensor means 175 can include an optical transmitter and/or receiver arranged to detect an optical signal transmitted through openings regularly disposed along and formed through a radial translation member near its curved edge. Thus, by counting instances and/or cycles of light transmission through the translation member, and/or a relative rate of such transmissions, the sensor and/or control means 175 can determine either or both of a position of the translation member and a rotational speed thereof.

In still another embodiment, a sensor 175 operatively coupled with one or more of the drive mechanisms can determine any or all of a rotational speed, direction, and/or position of a translation member. In embodiments where a rotational speed of a drive shaft or engagement member does not correspond directly with a rotational speed of a translation member, a control means can include and/or have operational access to an algorithm for deriving the latter from one or more of the former.

By such means, methods, and/or devices, it is possible to plan, pre-determine, program, control, detect, and/or alter one or more of a variety of operational parameters of an apparatus based at least in part upon an engagement or disengagement of a portion of an apparatus with, and/or detecting a signal from, a sensor means 175.

As mentioned earlier, a “neutral position” can be designated for an apparatus, or more particularly, for one or more of the platform members of an apparatus, and such neutral position can be configured to enable easy entry and/or exit from the device for a human subject. Because not all human subjects have the same physical capabilities, a neutral position designated for one subject can be different from that for another subject, and can be individually configured and designated relative to each subject's capabilities.

For example, a paralyzed and/or otherwise relatively immobile subject may most easily enter the apparatus from a mobile platform (e.g., gurney, stretcher, etc.) while in a supine position. Therefore, arranging the platform members into a relatively co-planar, horizontal arrangement enables assistants to position a subject's mobile platform relatively parallel to and next to the apparatus, and simply transfer the subject laterally onto the platform arrangement. This type of transfer is common, for example to transfer a patient from a gurney to an operating table. Therefore, such relatively co-planar, horizontal arrangement is an appropriate neutral position for many such patients.

Alternatively, an ambulatory subject may most easily enter and exit an apparatus in either a standing or sitting position. Therefore, the platform members can be positioned either relatively co-planar one with the other(s) in a relatively vertical position, with a torso support platform member in an upper position relative to a lower position of the one or more leg support platform member(s), enabling a subject to enter and/or exit in a standing neutral position. To achieve a neutral “sitting” position, either a torso support platform member can be positioned relatively vertically with one or more leg support platform members positioned relatively horizontally, or vice versa. Any of myriad alternative neutral positions can be designated and/or obtained wherein any of the platform members can be positioned anywhere within an arc range of motion within which a member can traverse, translate, rotate, etc.

Notably, in the event of a interruption of power, an internal system malfunction, or some other event which interferes with system operation, and/or which has the potential for interfering and/or altering a normal operation thereof, an apparatus could potentially injure a subject engaged therewith. Therefore, an embodiment of the invention includes one or more recovery means (e.g., system-interrupt means) for returning the system to a recovery condition in the event of a triggering event. A recovery condition is typically, but not exclusively, a pre-determined position to which each of the one or more independently movable support platform members can be returned to, for example, enable a human subject to safely disengage (e.g., exit, dismount, etc.) from the apparatus and/or system.

A recovery position may typically be a designated “neutral” position, as described above, but may also constitute a different arrangement of at least one of a torso support platform member and/or one or more leg support platform members from a designated neutral position.

Alternatively, upon initiation of a system interrupt condition, one or more of the platform members can simply be locked into their current positions to prevent uncontrolled translation which may present a risk of injury to a user, or damage to the apparatus or system or any part thereof. In yet another embodiment, a system interrupt condition may release one or more platform members so that they may articulate freely, but at only a limited rate of translation speed, wherein such speed is intrinsically regulated by resistance imparted by a gear train (e.g., resistance incurred through an arrangement of reduction gears, etc.) operatively engaged with one or more of the translation members. The embodiments listed here are by no means limiting, however, and can include any combination of those above, or any others as would be recognized by one having skill in the art in light of the descriptions provided herein.

A recovery means can include one or more of a mechanical device (e.g., interlock, gear train, etc.), an electrical circuit (e.g., either normally-open or normally-closed), a magnetic interface, or some other device, arrangement, or combination of such. For example, a bolt, friction brake, speed-limited gear, or some other mechanical device may normally be withheld from engagement by an electrically-actuated magnetic field (e.g., electromagnet). When electrical power to the apparatus is temporarily interrupted, thus weakening and/or eliminating a magnetic field, the bolt, brake, or other device is enabled to engage with a translation mechanism or some other portion of the apparatus (e.g., perhaps by a spring-loaded mechanism and/or arrangement operatively coupled therewith). Such engagement prevents and/or regulates the articulation of one or more movable portions of the apparatus relative to at least one or more other movable and/or normally stationary portions of the apparatus.

For example, a system-interrupt means, when actuated by a triggering event, can fix (e.g., secure, lock, etc.) one or more platform members into a position relative to one or more other platform members. When so fixed, the platform arrangement may either be likewise fixed into place, or may be allowed to pivot as a whole about a longitudinal axis of a fulcrum member.

Alternatively, one or more platform members may continue to be articulable through an arc of motion, e.g., arc 109a/109b with reference to FIG. 4, upon the occurrence of a triggering event. However, when any platform member arrives at a predetermined recovery position for that platform member, it is engaged by a portion of a system interrupt response means which fixes the platform member into position and prevents any further movement thereof. The continued movement after a triggering event, but prior to engagement by a system interrupt response means, can be apparatus driven, or can be responsive to a corresponding force applied by a user, whether the user is a human subject disposed at the platform arrangement or is an assistant or other operator of the apparatus not disposed at the platform arrangement.

As mentioned, a system interrupt response means can normally be withheld from engagement with movable portions of an apparatus while system power is present within an operable range, but operably engages therewith when system power departs from an operable range. Alternatively, a secondary power supply, e.g., UPS 209 with reference to FIG. 2a/2b, may be operably coupled with and comprise a portion of a system interrupt response means, and may be normally maintained with an open circuit condition in the presence of a normal system power condition. However, in response to an interruption to a normal power condition, the secondary power supply circuit may become closed, providing power to at least one or more system interrupt response components, devices, arrangements, circuits, or any combination thereof, which can comprise a portion or an entirety of a system interrupt means.

In one example, with reference to FIG. 2a/2b, a provision of electrical power from a secondary (e.g., system interrupt means) power supply 209 can fully replace normal system power, enabling an apparatus to continue to operate normally despite the lost of a primary power source. Alternatively, electrical power from a secondary power supply 209 can activate one or more user-detectable indicators (e.g., visible, audible, haptic, etc.) tending to indicate and provide awareness of an abnormal condition, to prompt the user to take a corrective action. In still another embodiment, an electrical charge provided by a responsively-activated secondary power supply can cause a movement-limiting member, device, arrangement, field, etc. to engage one or more movable portions of an apparatus, thus preventing and/or limiting articulation of one or more movable portions of the apparatus relative to at least one or more other movable and/or normally stationary portions of the apparatus.

A system-interrupt means can include a fully-integrated device, system, and/or arrangement, or can comprise any individual portion, component, circuit, member, arrangement, device, or combination thereof, which functions in whole or in part in response to an abnormal operational condition (e.g., triggering event), whether spontaneous or scheduled, whether unexpected or pre-determined, and whether intrinsic or extrinsic to an apparatus. Additionally, and as can be understood from the above provided descriptions, the embodiments of a system-interrupt response means (e.g., recovery means, etc.) are numerous rather than limited, and include many not explicitly listed or described herein, but which constitute equivalents thereof, and/or would be understood by one having skill in the art in light of the examples, functions, objectives described herein.

Inasmuch as the platform members of an apparatus are configured in embodiments to articulate substantially throughout an arc range of motion, gravitational forces can cause inadvertent dislocation of a portion of a human subject from one or more substantially inclined or declined platform members. Such dislocation can defeat a purpose of the apparatus at a minimum, and can lead to severe injury to a human subject in a worst case situation.

Therefore, an embodiment of the invention includes one or more retaining members coupled at one or more platform support members of an apparatus, wherein such retaining members are configured, either individually or cooperatively, to engage and secure a supported (anatomical) portion of a human subject (e.g., wrist, arm, leg, foot, chest, etc.) in a condition of relative positional stability relative to the one or more platform members. Typically, but not exclusively, one or more retaining members are disposed at and/or operatively coupled proximate to a user-receiving surface of the one or more support platforms, however, alternative placements and/or arrangements are likewise contemplated.

As shown in FIG. 1a and others, retaining members can include one or more bands 140 configured to retaining a subject's torso (or another anatomical portion) in position proximate to a platform member 107a/107b, one or more cuffs 141 configured to retain a subject's leg(s) (or another anatomical portion) proximate to a platform member 107a/107b, and/or other similarly configured and/or functioning retaining members. When employed, such retaining members can limit or prevent all or some portion of a human subject from dislocating relative to an initial position proximate the one or more platform members, and can thereby prevent injury and/or discomfort. Additionally, by securely retaining a subject in place, retaining members enable a more full range of motion of the platform members, which can provide additional benefits compared to a situation wherein a subject is not securely coupled relative to a platform member.

As seen at 142 in FIG. 1a, a retaining member can also be provided which does not encircle any portion of a subject's anatomy, unlike some embodiments of a band, cuff, or similar retaining member, but rather provides a weight bearing structure securely coupled with, for example, a platform member. A footboard 142 can be configured to bear all or some portion of a subject's weight when a platform arrangement and subject are oriented relatively vertically, and gravity urges the subject to displace longitudinally (toward a foot end thereof) relative to one or more of the platform members.

A similarly functioning retaining member can be configured to include or be formed of one or more bars, pegs, handles, plates, straps, projections, recesses, openings, or other structures which enable purchase by some portion of a user to resist displacement in one or more directions. Likewise, similar structures can be placed at alternative locations of a platform arrangement and/or any of the individual platform members. In at least one embodiment, such retaining members can be removed and replaced, retracted and deployed, or otherwise configured for at least a first less effectively-retaining position and a second more effectively-retaining position, with respect to an individual subject.

Retaining members can be adjustable to accommodate persons of different anatomical sizes (e.g., slender, robust, muscular, etc.), different proportions (e.g., longer torso or shorter torso, etc.), persons with anatomical anomalies (e.g., missing or malformed limbs, etc.), different age groups (e.g., children, adults, elderly, etc.), or other characteristics of a subject which indicate a benefit from and/or need for a different restraining member configuration. Additionally, in at least one embodiment, retaining members can be configured as rail structures coupled at one or more sides of the platform arrangement to prevent lateral dislocation of a subject, and may be configured similarly to side rails on a hospital bed.

Retaining members according to alternative components, structures, or arrangements can include a head strap, chin strap, helmet, padded neck collar, shoulder blocks coupled with a platform member beside and/or at a top of one or more shoulders, wrist and/or arm straps, a waist belt, boots, specially-adapted clothing (e.g., reciprocal hook and loop elements disposed at each of a platform member surface and a subject's clothing), and others not specifically listed herein. In general, a retaining member according to an alternative embodiment can be any structural feature performing a relatively equivalent function to any one or more of those described above, albeit by a somewhat different structural configuration and/or method, as would be understood by one having skill in the art, and as informed by the embodiments, purposes, objectives, structures, functions, and other descriptions provided herein.

Additionally, in alternative embodiments, a subject can engage with one or more retaining members entirely without the aid of another person, or may require the assistance of another person to properly secure one or more retaining members.

A retaining member can also be a textured surface coating, material, treatment, or other condition of one or more platform members, providing an enhanced level of friction between the surface of the platform member(s) and a surface of a human subject engaged therewith. An increased friction between a subject and a platform member helps to retain the subject in position throughout a greater range of platform member positions (e.g., angles and/or motions), increasing a corresponding gravitational force required to overcome the friction and cause dislocation of the subject.

Alternatively and/or additionally, one or more support platform member can be repositioned and/or replaced with a differently-configured platform member to safely, securely, and comfortably accommodate users of different anatomical sizes, proportions, configurations, etc. For example, a torso-supporting platform member can be removed and replaced with a longer but otherwise similarly configured platform member to accommodate a user possessing a longer-than-average torso (e.g., a professional basketball player). A likewise wider torso-supporting platform member can be utilized to accommodate a user with a larger-than-average girth (e.g., a sumo wrestler).

In another embodiment with reference to FIG. 1a, one or more platform members 107a/107c can be adjustably extended and/or dislocated along a longitudinal axis thereof (e.g., typically but not exclusively in an axis perpendicular to that of a pivot axis), toward or away from a respective one of the head end or foot end of a platform arrangement relative to a typical orientation of a human subject disposed thereupon. The extendibility of platform member 107a/107c is illustrated by dotted lines. For example, a platform member may be at least partially decoupled from a portion of an apparatus underlying and/or laterally located relative thereto, such as by removing, loosening, separating, detaching, or otherwise disengaging a fastener, clamp, latch, pin, hook-and-loop member, or any other detachable fastening apparatus, material, structure, and/or arrangement. The platform member may then be moved, slid, translated, dislocated or otherwise positionally adjusted and re-coupled with the apparatus in a longitudinally-shifted position.

In at least one embodiment, a platform member is coupled with one or more telescopically extensible structural members, wherein each extensible member can be longitudinally extended and/or collapsed by simply removing a retaining pin and applying a longitudinally-oriented force either of the platform member or one or more of the extensible members. However, the embodiments are broad rather than limited, and those specifically described herein are for illustrative purposes only, and any limiting inference derived therefrom improperly construes the embodiments more narrowly than what is conceived and implied herein. By adjusting a position of one or more platform members corresponding to a subject's anatomical features and/or proportions, it is also possible to properly position one or more of the retaining members (e.g., 140/141/142 of FIG. 1a) relatively consistently relative to each of the anatomical portions to be retained by or within the retaining member(s).

During articulation of a subject's anatomy through a series of motions, sheer forces can be applied between a subject-receiving surface of one or more platform members and a corresponding surface portion of the subject's anatomy (and/or clothing) in contact therewith. Typically, such sheer forces are longitudinally-oriented relative to the platform member, and are applied outwardly from a pivot axis when a subject's legs and/or lower torso are flexed ventrally relative to the upper torso, and are applied inwardly corresponding to dorsal flexion. Occasionally, such sheer forces can induce mild to severe discomfort in the subject corresponding at least to the portions of anatomy proximate the surface of the one or more platform members. In an elderly subject, whose skin is not as elastic and is therefore more fragile than that of a younger subject, tearing of the skin is a small but realistic risk.

Therefore, at least one embodiment includes a portion of the platform member which can dislocate and/or translate longitudinally in response to an applied sheer force during operation, without otherwise affecting the function of the apparatus. An threshold sheer force necessary to induce such dislocation can be adjusted by an adjustment mechanism operatively coupled therewith, and can comprise a operational parameter as described above.

Alternatively, a reciprocating longitudinal translation of a platform member corresponding directionally with an upward and/or downward motion of the platform member through an arc of motion, can be provided as a part of the normal operation and/or function of a platform member, without requiring an applied sheer force exceeding an operative threshold. This function can be attained through the use of one or more of a rod and/or cable member coupled at a first end thereof with a platform member, and at an opposing end thereof with another portion of the apparatus, wherein an upward motion of a platform member through an arc of motion causes the platform member to translate longitudinally outward from a pivot axis, and/or a downward motion causes the platform member to translate longitudinally inward toward a pivot axis, or vise versa.

As can be readily understood by one having skill in the art, adjusting a position of a platform member outwardly from a transverse pivot member (e.g., along a longitudinal axis perpendicular to a pivot axis of the pivot member), will typically increase a maximum radius (“arc radius”) traversed by a portion of the platform member through a pivot arc of motion about the pivot axis of the pivot member. Therefore, a base, support members, and other structural members of an apparatus will generally be configured to provide a clear path through the full arc range of motion for one or more of the platform members, whether fully-extended, fully-shortened, or anywhere within a full range of extendibility. Conversely, adjusting a position of a platform member in the opposite direction (e.g., inwardly toward a pivot member), will typically decrease a maximum arc radius traversed by a portion of the platform member through a pivot arc of motion about the pivot axis of the pivot member.

As shown in the embodiments of FIGS. 2a and 2b, a platform member 107a/107b and a translation member coupled therewith may typically form a relatively perpendicular arrangement (e.g., a ninety degree angle) which does not change substantially during translation of the translation member through a range of motion. However, in at least one embodiment, a torso support platform member, for example, is coupled with one or more of the radial translation members by a pivotable coupling arrangement. When so arranged, pivoting the translation member through an arc of motion about a pivot axis thereof further alters an angle formed between a portion of the translation member and a nominal human subject-receiving surface plane of the platform member.

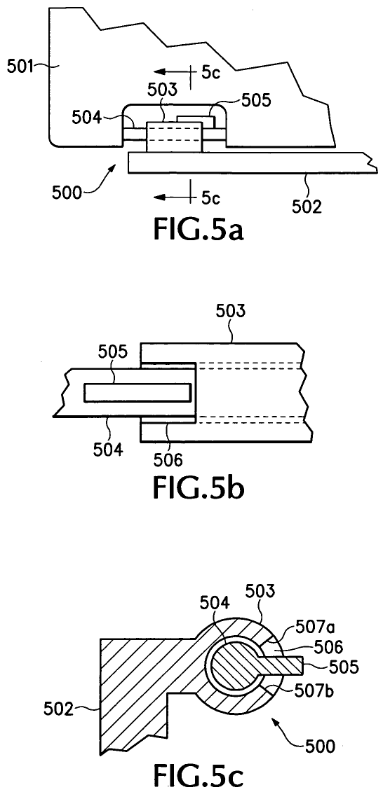

As shown in the exemplary, non-exclusive embodiment of FIGS. 5a-5c, a pivotable arrangement 500 can include one or more structural features of each of a platform member 501 and a translation member 502 configured to engage one another. Such engagement enables at least a range of pivotal movement of one with respect to the other, while still providing a strong load-bearing junction therebetween. By providing a pivotable arrangement 500 as described, one can pivot translation members on opposing sides of a platform member 501 in opposite directions, or in the same direction at different rates of speed or to a different degree, and cause the platform member to tilt (e.g., pivot, twist, etc.) along its longitudinal axis. The tilting thusly imparted rotates the upper torso of a user disposed at the platform member 501 either to his/her left or right side, rotationally flexing the upper torso relative to the hips and/or lower extremities.

In order to accommodate such tilting of the platform member 501, one of several accommodations will generally be provided. One accommodation includes the platform member being configured as two transversely separated, relatively-planar subject-engaging portions joined by a pivotable coupling. Therefore, the portion pivotably coupled with the transverse pivot member 106 does not tilt when the translation members are pivoted in opposite directions, but the portion of the platform more distally-located relative to the transverse member does pivot. While being rotationally-pivotable, the coupling between the two torso-supporting platform member portions does, however, provide substantial support along the longitudinal axis of the platform member so that articulation of the two platform members relative to each other is limited to only rotation/tilting about a shared longitudinal axis thereof.

A separate accommodation includes coupling the platform member 501 directly with the two or more translation members 502 via pivotable couplings, but not coupling it directly with the transverse pivot member 106. Therefore, the platform member is free to alter an angle relative to each translation member without being constrained by a separate engagement directly with the transverse pivot member.

Still another accommodation includes providing a deformable portion of the platform member 501 proximate to the coupling with the transverse pivot member 106, and a more rigid portion of the platform member 501 more distally relative to the pivot member 106. Therefore, applying a rotational force to the platform member by pivoting opposing translation members 502 in opposite directions causes a portion of the platform member to tilt while remaining relatively planar across its expanse. At the same time, the deformable portion of the platform member deforms (e.g., twists), departing somewhat from a state of substantial planarity, while maintaining a pivotable engagement with the transverse pivot member 106.

The accommodations listed here provide just a few examples, and are for illustrative rather than limiting purposes. Numerous other embodiments are contemplated, and are included within the scope of the invention. In general, any device, structure, arrangement, or composition providing a substantially equivalent function to that described herein is contemplated in at least one alternative embodiment.

As shown in FIG. 5a, a pivotable coupling between a translation member 502 and a platform member 501 can comprise a sleeve member 503 having a relatively cylindrical channel passing longitudinally therethrough. Passing through and retained by the channel is a relatively cylindrical shaft member 504 having a cross-sectional diameter which is smaller than a corresponding interior diameter of the channel, thus allowing rotational and/or longitudinal movement of the shaft member 504 within the channel of the sleeve member 503. Aiding free movement of the shaft member 504 within the channel may be a lubricating material disposed therebetween, or at either of the exterior of the shaft member 504 or the interior of the sleeve member 503.

A rotation-limiting means can also be provided to establish a maximum extent of tilt of the platform member, such as to prevent injury to a subject and/or prevent damage to the apparatus. In one embodiment, a rotation-limiting means comprises software controls which establish a maximum extent of pivotal translation of one or more of the translation members (e.g., by limiting an operation of the drive mechanism(s) operatively coupled therewith), therefore also limiting the amount of tilt of the platform member pivotably-coupled with the translation member(s).

In another embodiment, referring back to FIG. 1c, sensors 175 disposed at one or more portions of the apparatus detect an extent of rotational position of one or more of the translation members, and convey a corresponding signal to a control mechanism. The control mechanism recognizes the conveyed signal as representing a maximum rotational position corresponding to a platform member operational parameter (e.g., specifying a maximum extent of platform member tilting), and sends a responsive signal to a corresponding drive mechanism to either terminate translation of the translation member, and/or additionally, reverse a direction of translation of the translation member.

In yet another embodiment, as depicted in FIGS. 5a-5c, a rotation limiting means can be embodied as an arrangement of structural features. For example, a sleeve member 503 of a translation member 502 can include one or more notches 506 configured to receive one or more corresponding key member(s) 505 fixedly coupled with the and/or integrally-formed as a part of the shaft member 504. The notch(s) 506 are generally configured with interior boundaries 507a/507b which limit an extent of movement of a key member 505 within the notch(s), thus also limiting a range of rotation of the shaft 504 within the sleeve 503.

When a translation member 502 pivots in a direction opposite to that of an opposing translation member, thus tilting the platform member 501 and causing a shaft member 504 to rotate within a sleeve member 503, sufficient rotation of the shaft member 504 will bring a key member 505 into contact with an interior boundary 507a/507b of the notch 506, and will resist further rotation of the shaft member 504 within the sleeve member 503. A drive mechanism coupled with the translation member 502 can include a sensor configured to detect rotational resistance attaining and/or exceeding a pre-determined threshold (e.g., operational parameter), and convey a signal to either of a control mechanism and/or directly to the drive mechanism, causing the drive mechanism to terminate and/or reverse a direction of rotation of the translation mechanism 502.

The rotation-limiting means listed here provide just a few examples, and are for illustrative rather than limiting purposes. Numerous other embodiments are contemplated, and are included within the scope of the invention. In general, any device, structure, arrangement, or composition providing for a substantially equivalent function to that described herein is contemplated in at least one alternative embodiment.

### Alternative Embodiments

Although the embodiments described above include many advanced and highly functional components and arrangements, the embodiments also encompass relatively more simply embodiments of a powered drive mechanism (e.g., motor, etc.) applying a motive and/or resistive force to articulate a platform member in a relatively arc range of motion about a pivot axis. Additionally, in embodiments, at least one portion of a human subject (e.g., a foot) can remain in contact with a supporting surface or structure (e.g., floor, platform, stair, wall, etc.), while one or more of the subject's other anatomical portions operatively engages one or more portions of the apparatus.

In an embodiment, an apparatus and/or system includes a “teaching” function enabling a user to manipulate one or more movable portions of an apparatus into a position, or through a sequence of positions, and to save data corresponding to such positions and/or sequences. Through such embodiment(s), a user can assemble a program (e.g., plan, schedule) customized to a particular human subject, course of treatment, exercise regimen, calibration procedure, maintenance test, or for some other purpose or function. A “taught” program, sequence, etc. can be individually identified (e.g., named, numbered, etc.) and saved at a data storage means (e.g., utilizing magnetic, optical, solid-state, physical, or other data storage media) operatively coupled with or integrated into the system, and can be utilized thereafter by selecting and executing the identified program.

Execution of a taught program will cause one or more of the movable portions of an apparatus to operate a sequence of movements corresponding to and/or including all or some portion of those “taught” to the system during assembly of the taught program, whether in the same sequence or a different sequence. Accordingly, each movement in a taught program can be separately identified, and can therefore be rearranged to form alternative sequences which include either more or fewer iterations of each taught movement, assembled in any combination and/or sequence desired by a user.

A “taught” program can also be “debugged” either by reviewing data corresponding to position(s) or sequences of positions on a display device or other readable (e.g., human or machine readable) output from the system, or by executing the program on the system, observing the resulting actions of the movable portions of the apparatus, and altering a sequence and/or composition of movement-defining data in the program. Any errant data and/or motions can then be corrected by replacing the errant data with correct data, or by correctly positioning one or more movable parts and directing the system to insert data corresponding to the corrected position into the relevant portion of the taught program. An otherwise correct program can likewise be altered by addition, subtraction, or rearrangement of portions thereof.

Taught programs can also, in embodiments, be saved on transportable data storage media or media otherwise accessible to and/or by other similarly configured apparatuses or systems, or can be transmitted within a data-exchange network and/or transmitted from one network, apparatus, and or system to another. Therefore, a program created (e.g., by “teaching” or by another method) using one apparatus or system can then be executed on another similarly-configured and/or operationally-capable apparatus or system, obtaining the same or a similar operational result.

When executed on a data processing device (e.g., computer, etc.), a “taught” or otherwise prepared program, sequence, etc. causes movable portions of an apparatus to alter a position of one or more portions of a human subject's anatomy corresponding to the movable portions of the apparatus. However, an apparatus can also be operated instead by a user operating one or more controls of a controller, wherein such controls cause a corresponding, relatively-contemporaneous response in one or more movable portions of the apparatus. Thus, rather than a pre-determined schedule or sequence of movements, one or more movable portions of an apparatus can be controlled and actuated in relatively real-time by an operator.

The operator can be a human subject concurrently disposed at one or more platform members of the apparatus, or can be a person or entity located separately therefrom (e.g., an assistant, clinician, operator, technician, physical therapist, etc.). Further, the operator can be physically present at the same location as the apparatus, or can be located more remotely from the apparatus (e.g., a different room, building, city, state, country, etc.) but can transmit operational data (e.g., including one or more operational parameters, etc.) which is receivable by an apparatus or system.

As described above, openings can be formed along an arc of a semicircular translation member, and a light transmitted therethrough and detected by a sensor, to determine a rotational position of a translation member, and therefore, a rotational and/or angular position of a corresponding platform member relative to a “neutral” position, or within an arc range of motion. Alternatively, other marks, fiducials, recesses, elevated features, magnetic and/or magnetized elements, or other features detectable by a specially-configured sensing device or arrangement, can be disposed at relatively regular and/or operative intervals at a portion of a translation member and/or support member of an apparatus. Detection of a feature and/or a sequence of detections by a sensor can provide sufficient data to a control mechanism to determine one or more operational parameters, such as to enable calibration of an apparatus.

For example, two sensor disposed at different locations can be configured to detect features disposed at each of two translation mechanisms. A calibration program can further specify a sequence of motions for each of the two translation mechanisms, wherein detection by a first sensor of a specific position-indicating feature at one translation member should temporally correspond with detection by the second sensor of a specific position-indicating feature of the other translation member. A temporal mismatch in the detections of the two position-indicating features, or a failure to detect one of the features, can indicate a calibration error therebetween.

When detected, a calibration error can be investigated to identify a possible cause, such as wear of a drive mechanism, a change to a program of movement, damage to a sensor and/or a position-indicating feature, or some other cause. By remedying a hardware and/or software aberration, a calibration error can be resolved.

In one or more alternative embodiments, a radial translation member can comprise a piston and cylinder arrangement (e.g., pneumatic, hydraulic, etc.) configured to move a platform member in a radial translation path about a pivot axis. One or more piston and cylinder arrangements can couple at a first end with a support member, and at an opposing end with a platform member, with each such coupling being pivotable. Such pivotable coupling enables variation of an angle formed between the piston/cylinder arrangement and a platform member, for example, throughout a range of radial translation. Thus, linear translation of the piston within and relative to the cylinder applies a motive force and causes a corresponding and proportional radial translation of the platform member.

Alternatively, a piston and cylinder arrangement can include a plurality of pistons and/or cylinders, and one or more articulating arm members, such that the articulating arm members pivotably couple with one of a platform member or a support member, and additionally pivotably couple with another articulating arm member. A piston/cylinder arrangement can couple either with the one or more articulating arm members, or with an articulating arm member and either or a platform member or a support member. As with the above described embodiment, here also a linear translation of a piston within and relative to a cylinder applies a motive force and causes a corresponding and proportional movement of one or more articulating arm members, and therefore a corresponding and proportional radial translation of the platform member.

In either of the above described embodiments, it will be understood by one having skill in the art that the apparatus and/or system will include components configured and arranged to operate, and/or to control the operation of the piston and cylinder arrangement(s). Such components can include pumps, fluid or gas delivery conduits. (e.g., hoses, pipes, tubing, reservoirs, etc.), pressure sensors, electronic and/or manual controls (e.g., switches, valves, etc.), and others. Further, such components and arrangements could be operably coupled with other control systems as described herein to facilitate proper and safe operation, including error recovery.

At least one alternative embodiment of the invention contemplated herein includes an apparatus configured structurally, and at least partially functionally as well, similarly to standard items of household and/or office furniture. For example, an embodiment, either in a stored condition, or alternatively as configured for use, is configured substantially similarly to a chair, such as an upholstered, reclining and/or rocking chair commonly used in a user's living room. In such embodiment, the motors, drive gears, and other components can be aesthetically concealed within the base of the chair, translation and support members can be concealed within the arms and side supports of the chair, and the seat, back, and leg support portions of the chair can comprise the platform members. This is just one example, but numerous other alternative embodiments are likewise contemplated.

Inasmuch as the invention includes numerous embodiments of an apparatus, each configured structurally and/or operationally differently in one or more ways from another embodiment, sensors and/or position-indicating features may be configured and/or disposed about an apparatus in different quantities, positions, types, intervals, and/or other ways to provide monitoring and/or controlling one or more operational parameters thereof. Sensors can be coupled in communication with a drive mechanism and/or a control mechanism by a contiguous signal transmission medium and/or structure (e.g., an electrically-conductive wire, an optical-fiber, etc.), or can be communicatively-coupled via a wireless data transmission'signal and/or transmission means (e.g., for infrared, radio-frequency, microwave, and/or other signal conveyance).

The embodiments, however, are broad rather than narrow, and those listed above are provided herein for non-exclusive, illustrative purposes.

Advantages of the Invention

The advantages of the invention are numerous, and are summarized below rather than being discussed in great detail.

One or more embodiments of the invention are configured to receive a prone, supine, sitting, or standing human subject, and securely retain the subject in a condition of relative stability proximate to one or more platform members adapted for that purpose. A human subject-receiving surface of a platform member can be padded and/or configured to conform to a contour of a surface of a subject proximate the platform member surface. A platform member can also include one or more retaining members configured to engage and securely yet comfortably retain a portion of a subject's anatomy (e.g., arm, leg, head, shoulders, legs, feet, torso, etc.)

One or more embodiments of the invention enable articulating portions of a human subject's anatomy relatively to other portions, with either of an assistive or a resistive force applied thereto. Such articulation is achieved by one or more drive mechanisms applying either of a motive or a resistive force to one or more translation members, which in turn couple with and urge the one or more platform members through at least a portion of an arc range of motion. Alternatively, a drive mechanism, translation member, and/or another portion of an apparatus can resist articulation of one or more platform members through a range of motion in response to a force applied by a human subject.

Thus, a subject who is otherwise unable to articulate portions of their anatomy is rendered able to do so, either partially or entirely enabled by a motive force applied by the apparatus. Such articulation provides therapeutic benefits, including: reducing the shortening of muscles and/or loss of flexibility due to inactivity, increasing a range of motion and/or flexibility when such has been compromised in a subject, maintaining a range of motion to promote proper healing of an injured anatomical portion (e.g., after surgery, etc.), to help prevent and/or minimize formation of adhesions in a post-surgical subject (e.g., by repositioning abdominal organs through a series of guided movements), and other benefits.

In one or more embodiments, utilizing resistive forces applied by an apparatus antagonistic to a force applied by a subject provides physical benefits such as development of muscular strength, developing such strength throughout a range of motion, and guiding an anatomical portion through a range of motion while maintaining a proper orientation. In addition to enhancing muscular strength, such applications help prevent injuries during muscular conditioning exercises, ensure proper form to correctly develop targeted muscles and/or muscle groups for specific activities, and enable varying levels of resistance between exercises and/or throughout a range of motion of a particular exercise, to develop muscular strength effectively throughout a range of motion.

In particular, the core muscles in the lumbar and abdominal portions of a human subject's anatomy, which are most critical for good posture, prevention of injuries to and malfunctions of the spinal structure, and necessary for the safe and successful performance of many physical activities, are beneficially exercised, stretched, strengthened, and otherwise enhanced through use of one or more embodiments of the invented apparatus, system, and/or method.

One or more embodiments enable a user to control and/or monitor one or more operational parameters of the apparatus via a control mechanism, and/or via one or more sensors coupled with the apparatus and configured to indicate a condition of an operational parameter thereof. Additionally, a control mechanism can enable such control and/or monitoring either locally, or from a position remotely located relative to the apparatus, wherein signals are transmitted and/or otherwise conveyed between the control mechanism and the apparatus.

One or more embodiments also include a system-interrupt response means configured to enable continued control over and/or operation of the system upon the occurrence of a triggering event (e.g., loss of power, failure of a component, etc.). A system-interrupt response means can also immobilize one or more of the platform members to prevent uncontrolled movement thereof, or can enable one or more platform members to assume a neutral position at a controlled rate of speed when a triggering event occurs.

Within an embodiment, not only can one or more platform members pivot independently from one another about a pivot axis perpendicular to a longitudinal axis of the platform members, but one or more of the platform members can also pivot about a longitudinal axis thereof. Therefore, strength and flexibility can be enhanced not only longitudinally along a human subject's anatomy, but trunk-rotational strength, flexibility, and range of motion can likewise be improved.

Through the use of a control means including a “teaching” function, any of a wide range of sequential movements of one or more portions of an apparatus can be assembled into a continuous sequence, with one or more operational parameters assigned to a movement or plurality of movements of the sequence. A taught program (e.g., a program created or altered by use of a teaching function) can then be stored in a memory for later execution, editing, or other purposes. Additionally, programs, whether created by teaching or by some other method, can be transferred to and executed on one or more other apparatuses and/or systems via a data storage medium readable thereby, or by a transmitted signal receivable at an apparatus or system.

An apparatus provides a stable, secure structural arrangement wherein a human subject can feel safe and confident throughout an engagement therewith, and with which a subject can easily engage and disengage, either with or without the assistance of another person.

Accordingly, numerous benefits can be realized through the great number of conceived embodiments of the invention, many of which are not herein specifically listed, and others of which may be recognized by one having skill in the art in light of the descriptions provided herein.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

It is further intended that any other embodiments of the present invention that result from any changes in application or method of use or operation, configuration, method of manufacture, shape, size, or material, which are not specified within the detailed written description or illustrations contained herein yet would be understood by one skilled in the art, are within the scope of the present invention.

Finally, those of skill in the art will appreciate that portions of the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that embodiments of the methods and system of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

We claim:

1. An anatomical flexion apparatus comprising:
a relatively rigid support structure comprising opposing relatively planar support members;
a fulcrum member coupled with the support structure at each of the opposing support members and traversing a distance therebetween;
an articulable platform arrangement operatively coupled with and pivotable relative to the fulcrum member, wherein the platform arrangement comprises a torso support portion operatively coupled with and extending outward from the fulcrum member in a first direction, and one or more lower extremity (leg) support portions each operatively coupled with and extending outward from the fulcrum member in a second direction, and wherein each of the torso support portion and the one or more leg support portions are independently pivotable relative to the fulcrum member;
one or more radial translation members operatively coupled with the fulcrum member and pivotable about a longitudinal axis thereof, each of the one or more radial translation members being further coupled with one of the torso support portion or the one or more leg portions; and
one or more drive mechanisms each operatively coupled with at least one of the one or more radial translation members, and configured to cause the at least one radial translation member to urge either or both of the torso support portion and the one or more leg support portions through an arc of motion found within a range of approximately zero to approximately one hundred eighty (0-180) degrees, and wherein at least a substantial portion of the arc of the torso support portion is non-overlapping with the arc of the one or more leg support portions.

2. The apparatus of claim 1, further comprising:
a drive mechanism control means operatively coupled with the one or more drive mechanisms and including a programming interface, a processor-based drive control circuit, and one or more drive signal channels.

3. The apparatus of claim 1, further comprising:
a positional feedback means operatively coupled with the one or more drive mechanisms and configured to indicate a rotational position of the one or more radial translation members.

4. The apparatus of claim 1, further comprising:
one or more retaining members coupled at either or both of the torso support portion and the one or more leg support portions, and configured to engage and secure a supported portion of a human subject in a condition of relative positional stability thereat.

5. The apparatus of claim 1, wherein either or both of the torso support portion and the one or more leg support portions are adjustably extensible along at least a longitudinal axis thereof extending outwardly from and approximately perpendicular relative to the fulcrum member.

6. The apparatus of claim 1, wherein the one or more drive mechanisms are operatively configured for either or both of applying an assistive force to urge either or both of a torso support portion and the one or more leg support portions in a rotational movement cooperative with a human subject's applied muscular force, and applying a resistive force to either or both of a torso support portion or the one or more leg support portions antagonistic to a human subject's applied muscular force.

7. The apparatus of claim 1, wherein either or both of a radial-translation member and a drive mechanism is configured to apply either of a relatively constant force or a relatively-variable force throughout a range of motion.

8. The apparatus of claim 1, further comprising:
a system-interrupt response means configured to return at least the torso support portion and the one or more leg support portions to a neutral position in a controlled fashion in response to a system-interrupt condition.

9. The apparatus of claim 1, wherein the torso support portion is coupled with one or more of the radial translation members by a pivotable coupling arrangement configured to alter an angle formed between a radial translation member and a human subject-receiving surface plane of the torso support portion in response to radial translation of the one or more radial translation members.

10. The apparatus of claim 1, wherein the one or more translation members comprise at least first and second relatively planar semicircular gears positioned adjacently and relatively parallel-planar with respect to one another proximate to an end of the fulcrum member, wherein at least a portion of the first gear bypasses and substantially overlaps at least a portion of the second gear as the first gear independently proceeds through at least a portion of a pivot arc about the longitudinal axis of the fulcrum member.

11. A lower trunk flexion system, comprising:
two or more independently movable support platforms operably pivotable about a common axis and throughout opposing, substantially non-overlapping approximately semicircular arcs of motion;
one or more force translation mechanisms operatively coupled with each of the two or more support platforms, and configured to urge each respective platform throughout one of said respective arcs of motion;
one or more force-generating means configured to engage a force translation mechanism and to apply a motive force thereto according to one or more user-determined force parameters;
a relatively rigid base structure including one or more support members, and further including one or more pivot members each coupled with at least one of the one or more support members and further coupled with one or more of the support platforms, and
a control means configured to receive input corresponding to the one or more user-determined operational parameters and to convey a corresponding operative signal to the one or more force-generating means.

12. The system of claim 11, further comprising:
a recovery means for returning the system to a recovery condition in the event of a triggering event, wherein the recovery condition comprises a pre-determined position for each of the two or more independently movable support platforms, the pre-determined positions being configured to enable a human subject to safely disengage from the system.

13. The system of claim 11, further comprising:
one or more retaining members presented proximate to a user-receiving surface of the one or more support platforms, each retaining member configured to engage a portion of a user's anatomy and to securely retain said anatomical portion at a position proximate to said user-receiving surface as the one or more support platforms pivot throughout an arc of motion.

14. The system of claim 11, further comprising:
support platform adjustment means for accommodating human subjects of differing physical dimensions while positioning one or more of the retaining members relatively consistently relative to each of said anatomical portions to be retained by the one or more retaining members.

15. The system of claim 11, wherein the base structure is configured to enable each of the two or more independently-movable support platforms to extend outwardly from and pivot about a central axis-defining member, wherein at least one of the two or more support platforms is pivotable in an arc having a range of motion found within a range of approximately zero to approximately one hundred eighty (0-180) degrees, and at least another of the two or more support platforms is pivotable in an opposing arc having a range of motion found within the range of approximately zero to approximately one hundred eighty (0-180) degrees, and wherein the arc and the opposing arc are substantially non-overlapping.

16. A method of applying a force to one or more anatomical portions of a human subject while articulating the portions through a range of motion, comprising:
providing an apparatus configured to receive and position a human subject proximate two or more independently-articulable platform members, wherein at least one of the two or more platform members is configured to pivot throughout a range of motion found within a range of approximately zero to one hundred eighty (0-180) degrees about an axis lying perpendicular to a longitudinal axis of the platform member;
positioning a human subject proximate the two or more platform members, and securing one or more portions of the subject's anatomy thereto by one or more retaining members;
providing one or more operational control parameters at a controller means of the apparatus;
activating a powered-operated force-generating mechanism;
applying one of a motive force or a resistive force to one or more of the platform members by the force-generating device, wherein the applied force corresponds to the one or more applied operational control parameters; and
altering an angle between a subject-receiving surface plane of one of the platform members relative to a subject-receiving surface plane of another platform member, wherein the altered angle is acute with the platform members each arranged at a first cooperative position and is obtuse with the platform members each arranged at a second cooperative position.

17. The method of claim 16, further comprising:
providing one or more radially-translating force-conveying members coupled with each of the force-generating mechanism and at least one of the platform members.

18. The method of claim 16, further comprising:
providing one or more of the platform members with means for enabling longitudinal translation thereof, wherein longitudinal translation comprises one or both of altering a maximum radius of the pivot arc by longitudinally repositioning a platform member relative to the pivot axis to accommodate a length of an anatomical portion of a human subject, and displacing a platform member outwardly relative to the pivot axis in response to a sheer force applied to the platform member by a human subject during one or both of ventral and dorsal flexion of the trunk of the subject.

19. The method of claim 16, wherein the provided one or more operational control parameters are memory-based and represent plural sequential operations comprising a schedule of operation.

20. The method of claim 19, wherein one or *more of the memory-based parameters are user-programmable.

21. The method of claim 16, further comprising:
providing a means for transporting the apparatus from a first relatively stationary location to a second relatively stationary location, wherein the means for transporting the apparatus is integrally-coupled with the apparatus.

22. The method of claim 16, further comprising:
one of increasing, decreasing, or terminating either of the applied motive force or resistive force in response to an opposing force applied by a human subject exceeding a pre-determined threshold.

23. An apparatus, comprising:
opposing relatively circular support structures each including a raceway extending substantially around a periphery thereof;
one or more curvilinear conveyor mechanisms at least partially housed within and translatable throughout a raceway of a respective one of the support structures;
one or more drive motors operatively coupled with each conveyor mechanism by a gear train arrangement extending therefrom and configured to relatively independently translate each conveyor mechanism in an at least semicircular path along a respective raceway;
a relatively horizontal fulcrum member extending at least partially between the respective support structures;
a plurality of platform sections each pivotably coupled at an end thereof with the fulcrum member, and each further operatively coupled at an opposing end with at least one of the conveyor mechanisms, wherein translation of the at least one conveyor mechanism causes an end of a platform section coupled therewith to pivot about the fulcrum member throughout a range of motion found within the range of approximately zero to approximately one hundred eighty (0-180) degrees, the plurality of platform sections further collectively configured when positioned in a neutral condition to receive and retain either of a prone or supine human subject; and
a means for controlling a translation parameter of the one or more conveyor mechanisms, wherein the translation parameter includes one or more selected from the group consisting of an extent of translation within a total available range of motion, a rate of speed of translation, a schedule of repetitive bi-directional translation, and an amount of applied force during translation.

24. An apparatus, comprising:
two or more opposing relatively independently-rotatable semicircular gear members pivotably coupled with a common transverse axial member;
a plurality of substantially triangular arrangements of rigid support members configured with the axial member traversing at least therebetween, the axial member further being supported in an elevated, substantially-horizontal position thereby;
one or more drive motors operatively coupled with one or more drive gears configured to engage a semicircular gear member and cause the semicircular gear member to pivot about a longitudinal axis of the axial member by a rotary motion of the one or more drive gears; and
a plurality of relatively-planar platform members collectively configured as a platform suitable when relatively horizontally arranged to receive and retain either of a supine or prone human subject, at least one of the platform members lying substantially opposite at least another of the platform members relative to a vertical plane longitudinally-bisecting the axial member, and each of the platform members being coupled with at least one of the semicircular gear members and pivotable about a longitudinal axis of the axial member by a rotary motion thereof.

25. The apparatus of claim 24, further comprising:
a means for selectively increasing and decreasing an arc radius traversed by one or more platform members throughout a range of motion by a respective one of longitudinally extending and shortening at least a portion of the one or more platform members outwardly from the longitudinal axis of the axial member.
